(19) United States
(12) Patent Application Publication
(10) Pub. No.: US 2026/0043284 A1
(43) Pub. Date: Feb. 12, 2026

(54) ASSEMBLY FOR GUIDING A MOVABLE FURNITURE PART

(71) Applicant: Julius Blum GmbH, Hoechst (AT)

(72) Inventor: Guenter SCHWARZMANN, Dornbirn (AT)

(21) Appl. No.: 19/360,532

(22) Filed: Oct. 16, 2025

Related U.S. Application Data
(63) Continuation of application No. PCT/AT2024/060149, filed on Apr. 15, 2024.

(30) Foreign Application Priority Data
Apr. 18, 2023 (AT) A 50283/2023

(51) Int. Cl. E05D 15/26; E05D 15/58

(52) U.S. Cl. CPC E05D 15/264; E05D 15/58; E05D 2015/586; E05Y 2201/654; E05Y 2201/668; E05Y 2201/672; E05Y 2900/212

(57) ABSTRACT

An assembly can guide a movable furniture part on a stationary furniture part. The assembly includes a first guide system to be fastened to the stationary furniture part and a second guide system to be fastened to the stationary furniture part at a vertical distance from the first guide system. The two guide systems each have a guide and a guide body mounted to be displaceable on the guide; a support on which the movable furniture part is to be fastened and which is connected to the two guide bodies of the guide systems in a movement-coupled manner; and a compensation device for compensating for a tilting moment of the support, or of the movable furniture part arranged thereon, about a tilting axis. The compensation device includes a cable pull device, and a pretensioning device which can apply a force to the support.

The present application is a continuation of International Application PCT/AT2024/060149 filed on Apr. 15, 2024. Thus, all of the subject matter of International Application PCT/AT2024/060149 is incorporated herein by reference.

### BACKGROUND OF THE INVENTION

The present invention relates to an assembly for guiding a movable furniture part, preferably a sliding door or folding-sliding door. The invention furthermore relates to a piece of furniture having such an assembly and a method for compensating for a tilting torque using such an assembly.

Basically, the challenge when guiding a sliding door or folding-sliding door on a furniture wall is that the sliding door or folding-sliding door tends to tilt due to its weight and a resulting tilting torque, which then leads to the door becoming wedged between the guides of the guide systems, which are vertically spaced apart from one another, and thus makes it impossible or at least significantly more difficult to slide the door.

A number of assemblies are known from the prior art which propose a compensation device to compensate for such a tilting torque in order to avoid the negative effects described above. For example, DE 28 47 578 A1 discloses a compensation device having a cable pull device. The cable pull device has a cable which can absorb loads resulting from the tilting torque.

However, in particular with folding-sliding doors, such an assembly results in the problem that in a closed position, i.e. when the door leaf or the door leaves of the folding-sliding door are closed, the tilting torque no longer acts in one plane with the guides of the guide systems. As a result, a cable of the cable pull device is no longer sufficiently loaded, so that the folding-sliding door can no longer be held in position by the compensation device. This can make it difficult to open the folding-sliding door. Increased wear and an overall visually unfavourable appearance can also be the result.

The applicant's own AT 522708 solves this problem by a pivoting lever mechanism which is provided in addition to the cable pull device.

The disadvantage is the relatively complex construction of such a pivoting lever mechanism, which also requires a large amount of space. Furthermore, the installation of such an assembly is difficult and complex. Finally, a pivoting lever mechanism is also cost-intensive.

### SUMMARY OF THE INVENTION

The object of the present invention is to provide an assembly for guiding a movable furniture part, preferably a sliding door or folding-sliding door, which is improved in relation to the prior art, a piece of furniture having such an assembly, and a method for compensating a tilting torque using such an assembly

In the assembly for guiding a sliding door or folding-sliding door on a furniture wall, at least one pretensioning device is provided, via which the support can be subjected to a force, preferably in the direction of a longitudinal extension of the guide of at least one of the guide systems, at least in a closed position of the movable furniture part.

The support can therefore be subjected to a force via the pretensioning device. This loads the cable of the cable pull device again, so that the cable pull device functions as intended even in a closed position and a folding-sliding door can be held in position.

In relation to the known solution, both the complexity and space requirement and also the manufacturing costs of an assembly according to the invention can be reduced.

According to the invention, a piece of furniture is furthermore provided having at least one fixed furniture part, at least one movable furniture part, preferably a sliding door or folding-sliding door, and at least one assembly according to the invention for guiding the movable furniture part on the fixed furniture part, preferably wherein the movable furniture part can be arranged in a shaft-shaped cavity of the furniture.

With regard to a method for installing an assembly according to the invention, in an open position and when moving the support or a movable furniture part arranged thereon between an open position and a closed position, loads resulting from a tilting torque are absorbed by the cable pull device. The support is brought into contact with the pretensioning device at least in the closed position, preferably shortly before reaching the closed position or an intermediate position, which pretensioning device exerts a force on the support, preferably in the direction of a longitudinal extension of the guide of at least one of the guide systems.

The pretensioning device can have at least one force accumulator, preferably a spring, particularly preferably a compression spring. In particular, if a spring or compression spring is provided, this represents a simple option for implementing a pretensioning device.

Preferably, the pretensioning device has at least one plunger for contacting the support. This also contributes to a simple and cost-effective construction of a pretensioning device.

If the pretensioning device has at least one force accumulator and at least one plunger, the pretensioning device is essentially designed as a spring plunger.

The pretensioning device can also be arranged on the fixed furniture part and/or the second guide system. Alternatively, the pretensioning device can be arranged on the support. The position of the pretensioning device can therefore be selected in the best possible manner depending on external conditions, for example the available space in a piece of furniture.

Preferably, a force between 10 N and 20 N, preferably 30 N, can be exerted on the support via the pretensioning device. It has been shown that such a force is sufficient to tension a cable of a cable pulling device accordingly and thus ensure proper functioning of the compensation device even in a closed position.

Furthermore, the pretensioning device comprises a housing. It has proven to be advantageous if the force accumulator is arranged in the housing and/or the plunger is movably mounted in the housing.

Particularly preferably, the support can be subjected to a force in the area of a lower end of the support via the pretensioning device at least in a closed position. As a result, the pretensioning device acts on a support at essentially the same point as a tilting torque, allowing the compensation device to act accordingly.

Preferably, the at least one cable pull device has at least one, preferably exactly one, cable which is fastened to the support with one end, preferably with both ends. If only one cable is provided, the construction and installation of the assembly is simplified even further.

Furthermore, the at least one cable pull device has at least one cable tensioning device, using which the tension of a cable of the at least one cable pull device can be adjusted, preferably wherein the at least one cable tensioning device is arranged on the support.

Furthermore, the at least one cable pull device has at least one deflection device, preferably having a deflection pulley, by which a cable of the at least one cable pull device can be deflected.

These measures facilitate the installation of the cable and improve the stability and rigidity of the assembly.

According to a further exemplary embodiment of the invention, the at least one deflection device is arranged or can be arranged on the fixed furniture part and/or a guide system.

Preferably, the compensation device is at least partially, preferably completely, pre-installed on the support in a delivery state of the assembly. This makes it much easier to install the assembly on a fixed furniture part.

According to a further exemplary embodiment, the force accumulator acts between the support and a cable terminus of the cable, and preferably the cable is arranged at least in some areas within the force accumulator. In this case, the cable of the cable pull device is pre-tensioned via the pretensioning device so that the cable pull device functions perfectly even in the closed position.

Furthermore, the pretensioning device comprises a stop, wherein the stop is arranged on the fixed furniture part, wherein at least in a closed position a stop plate arranged on the support can be brought into contact with the stop. This stop is used to reliably bridge any gap between the support and the fixed part of the furniture in the closed position.

### BRIEF DESCRIPTION OF THE DRAWINGS

Further details and advantages of the invention will be explained in more detail below with reference to the drawings, in which:

FIG. 1a is a schematic perspective view of a piece of furniture in an open position,

FIG. 1b is a schematic perspective view of a piece of furniture in an intermediate position,

FIG. 1c is a schematic perspective view of a piece of furniture in a closed position,

FIG. 2 is a schematic perspective view of a part of a piece of furniture in an intermediate position,

FIG. 3a is a schematic perspective view of a part of a piece of furniture in a closed position,

FIG. 3b shows detail A of FIG. 3a,

FIG. 3c shows detail B of FIG. 3b,

FIG. 4a is a schematic side view of a part of an assembly and a movable furniture part,

FIG. 4b shows detail A of FIG. 4a,

FIG. 4c shows detail B of FIG. 4a,

FIG. 5a is a schematic perspective view of a pretensioning device,

FIG. 5b is a schematic exploded view of a pretensioning device,

FIG. 5c is a schematic sectional view of a pretensioning device,

FIG. 6a is a schematic view of a further exemplary embodiment of a pretensioning device, and

FIG. 6b is a further schematic view of the pretensioning device according to FIG. 6a.

### DETAILED DESCRIPTION OF THE INVENTION

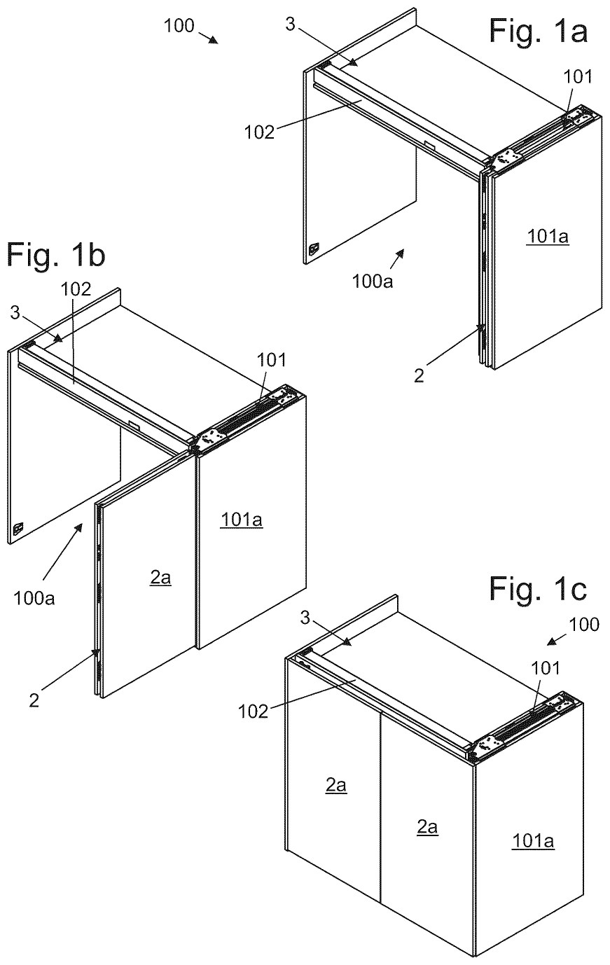

FIG. 1a shows a schematic, perspective view of a piece of furniture 100 in an open position, FIG. 1b shows the corresponding intermediate position, and FIG. 1c shows the corresponding closed position.

A cavity 101, which is formed by two spaced-apart furniture walls 101a, is provided laterally to the furniture 100. A movable furniture part 2, in this embodiment a folding-sliding door, can be lowered into this cavity 101 when folded. When the folding-sliding door 2 is spread open, it conceals the interior 100a of the furniture 100.

The movable furniture part 2 is composed of two door leaves 2a, which are folded together in the positions shown in FIGS. 1b and 1c. From the intermediate position in FIG. 1b, the movable furniture part 2 can be transferred into a closed position in which the door leaves 2a enclose an angle which is greater than 0° (FIG. 1c).

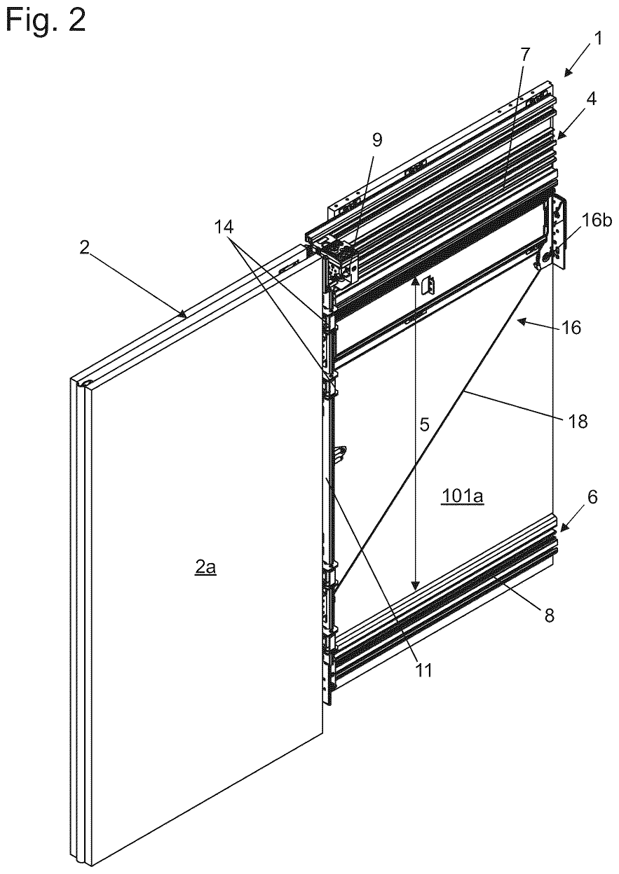

FIG. 2 shows a schematic perspective view of a part of a piece of furniture 100 in an intermediate position, An assembly 1 can be seen which has two guide systems 4, 6 arranged on a furniture wall 101a. The first guide system 4 is arranged spaced apart at a vertical distance 5 from the second guide system 6.

The guide systems 4, 6 each comprise a guide 7, 8 and an associated guide body 9, 10. The guide bodies 9, 10 are movably mounted on the associated guide 7, 8. The guide bodies 9, 10 are also connected to a support 11, so that the support 11 is movably mounted on the fixed furniture 25 part 3 via the guide system 4, 6.

Multiple hinges 14 are provided on the support 11, via which a movable furniture part 2 is pivotably mounted on the support 11.

In addition, a cable 18 of the cable pull device 16 can be seen.

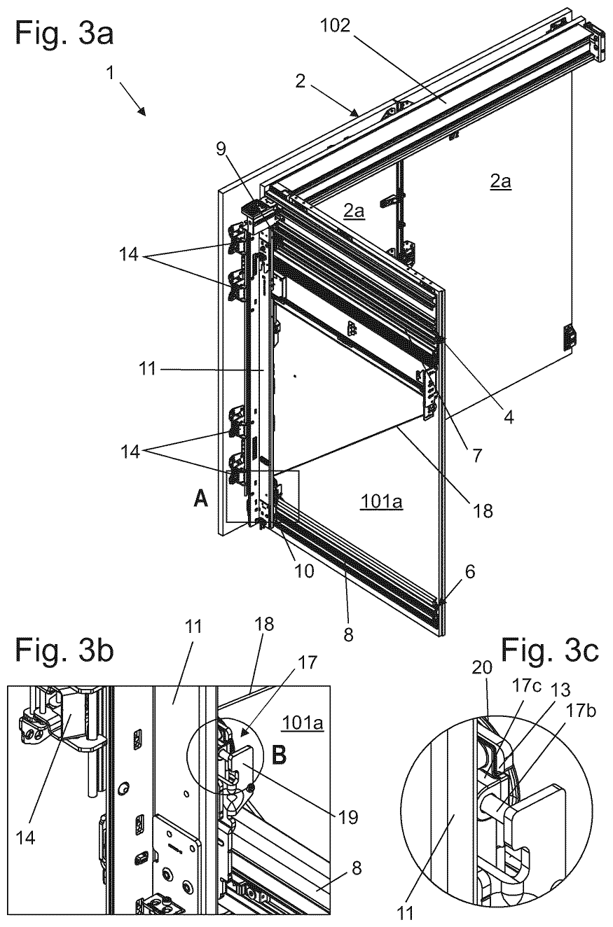

FIG. 3a shows a schematic, perspective view of a part of a piece of furniture 100 in a closed position, FIG. 3b shows detail A of FIG. 3a, and FIG. 3c shows detail B of FIG. 3b.

The furniture 100 is arranged in a closed position so that the movable furniture part 2 conceals an interior 100a of the furniture.

In this exemplary embodiment, the pretensioning device 17 is arranged on the fixed furniture part 3 (furniture wall 101a) or on the second guide system 6 via a holder 13 for a deflection pulley 20 of a deflection device 16b. A stop plate 19 is provided on the support 11, which can be contacted by a plunger 17b of the pretensioning device 17. It can also be provided that the pretensioning device 17 is arranged on the support 11 and the stop plate 19 is arranged on the fixed furniture part 3.

The pretensioning device 17 can therefore exert a force on the support 11 via the stop plate 19. It can be seen that the pretensioning device 17 already exerts a force on the support 11 in an intermediate position according to FIG. 1b. In particular, the plunger 17b can also come into contact with the stop plate 19 shortly before reaching the intermediate position.

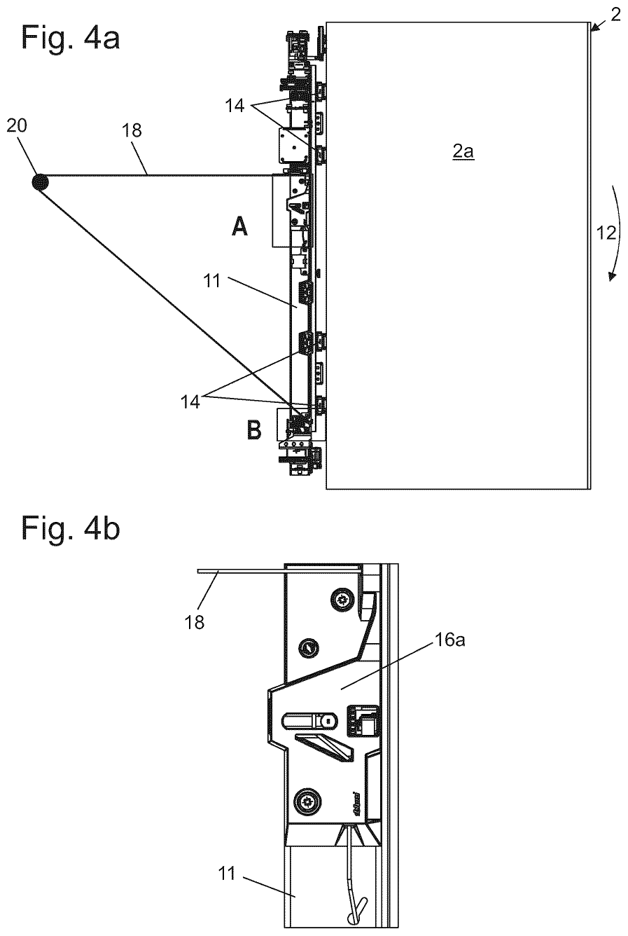

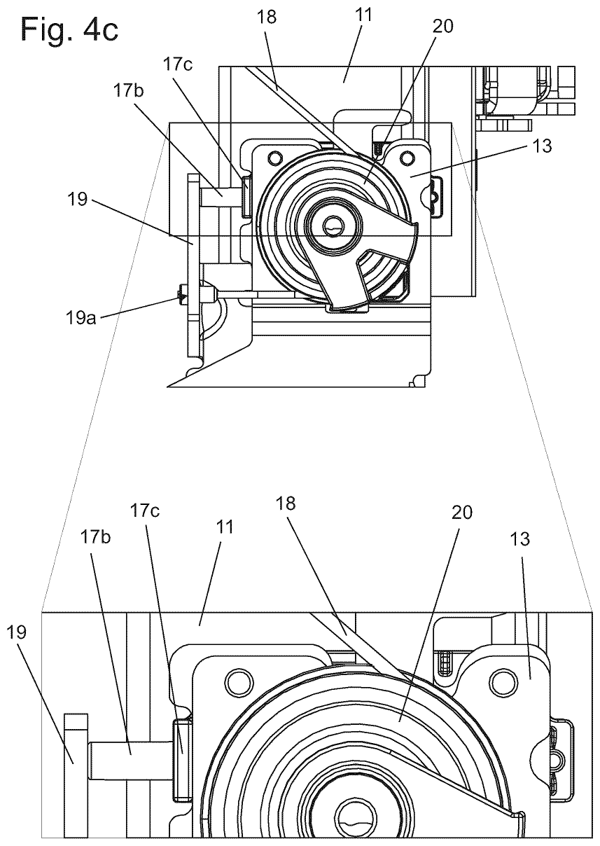

FIG. 4a shows a schematic side view of a part of an assembly 1 and a movable furniture part 2. It can be seen how the tilting torque 12 of the movable furniture part 2 acts on the support 11. The resulting loads can be absorbed and the tilting torque 12 can be compensated for via the cable 18 of the cable pull device 16.

A cable tensioning device 16a is arranged on the support 11, which is shown again in FIG. 4b. During installation of the assembly 1, the cable 18 is inserted into the cable tensioning device 16a and tensioned. The cable tensioning device 18 can be designed as desired.

FIG. 4c shows detail B of FIG. 4a. It can again be seen that the pretensioning device 17 is arranged on a holder 13 for a deflection pulley 20 of a deflection device 16b. The cable 18 is deflected via the deflection pulley 20 and is fastened to a fastening point 19a on the stop plate 19. The cable 18 is thus fastened to the support 11 via the stop plate 19 at this end. The other end of the cable 18 can also advantageously be arranged on the support 11.

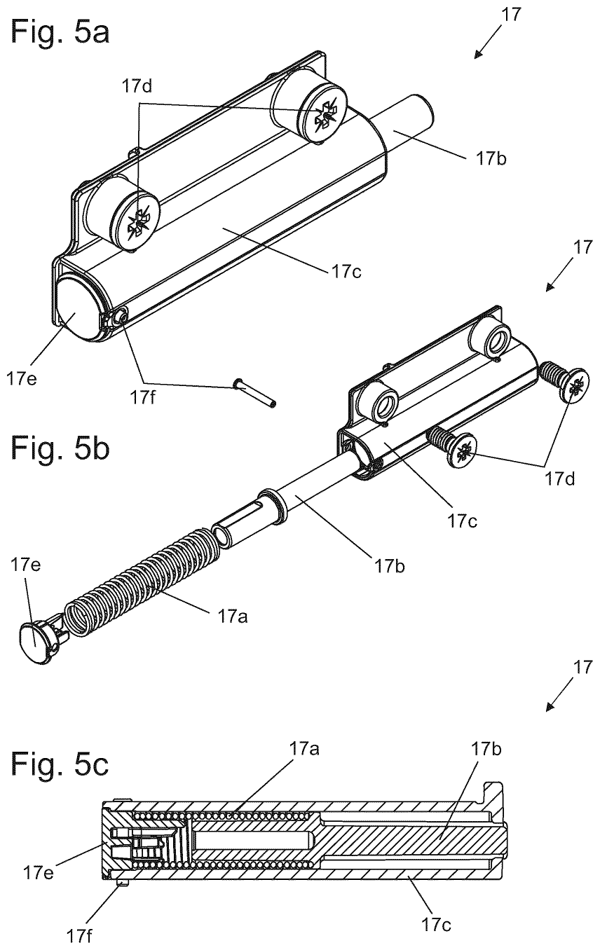

FIG. 5a shows a schematic, perspective view of a pretensioning device 17, FIG. 5b shows a corresponding exploded view, and FIG. 5c shows a corresponding sectional view.

The pretensioning device 17 comprises a housing 17c. The plunger 17b is guided in the housing 17c and is acted upon via the force accumulator 17a in the form of a compression spring. A cover cap 17e, which is fixed in the housing 17c via a locking pin 17f, is used a counter bearing for the force accumulator 17a.

The pretensioning device 17 can be fastened on the holder 13 via fastening means 17d, here in the form of screws, which can be led through openings in the housing 17c. In principle, however, all suitable means can be used as fastening means 17d.

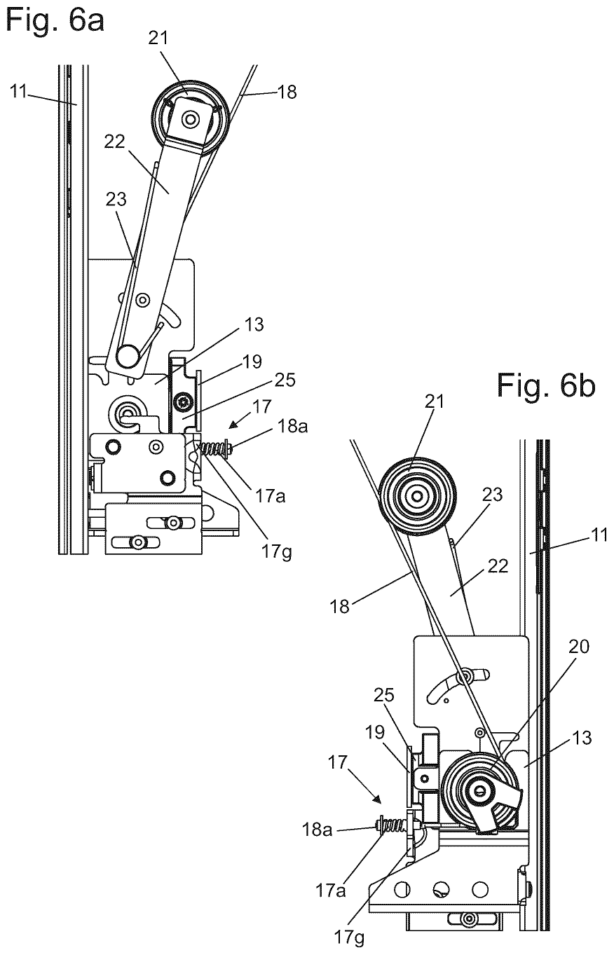

FIG. 6a shows a schematic view of a further exemplary embodiment of a pretensioning device 17. The pretensioning device can be seen from a side facing away from the furniture wall 101a. FIG. 6b shows a view from a side facing toward the furniture wall 101a.

In this exemplary embodiment, the pretensioning device 17 comprises a force accumulator 17a in the form of a compression spring. The cable 18 is led through the force accumulator 17a, wherein a cable end 18a rests on one end of the force accumulator 17a. The other end of the force accumulator 17a rests on an angle 17g which is arranged on the support 11 or is directly or indirectly connected thereto. The cable 18 is thus mounted on the support 11 via the pretensioning device 17.

The support 11 is only partially shown in FIGS. 6a and 6b, since it would conceal a large part of the pretensioning device 17, at least in FIG. 6a.

Furthermore, a stop 25 can be seen, which is fastened to the holder 13. The stop plate 19 arranged on the support 11 can come into contact with this stop 25, at least in a closed position.

In this exemplary embodiment, the force accumulator 17a exerts a force parallel to the longitudinal extension of a guide 7, 8 on the angle 17g and thus on the support 11. As a result, the stop plate 19 is pressed against the stop 25 so that it always rests against the stop 25 in the closed position. This also loads the cable 18 of the cable pull device 16 again, so that the cable pull device 16 functions as intended even in a closed position and a folding-sliding door can be held in position.

The stop 25 can, for example, be manufactured from a plastic. This improves the damping properties of the stop 25 and results in less noise emission when the stop plate 19 hits the stop 25.

In FIGS. 6a and 6b a support roller 21 can also be seen. The support roller 21 is rotatably mounted on a lever 22. The lever 22 is pivotably mounted on the holder 13 and is pretensioned in the direction of the cable 18 by a spring 23, here a torsion spring. As a result, the cable 18 is pre-tensioned via the support roller 21, which assists the pretensioning device 17.

### LIST OF REFERENCE SIGNS

1 assembly
2 movable furniture part
2a door leaf
3 fixed furniture part
4 first guide system
5 vertical distance
6 second guide system
7 guide
8 guide
9 guide body
10 guide body
11 support
12 tilting torque
13 holder
14 hinge
15 compensation device
16 cable pull device
16a cable pretensioning device
16b deflection device
17 pretensioning device
17a force accumulator
17b plunger
17c housing
17d fastening means
17e cover cap
17f locking pin 17g angle
18 cable
18a cable terminus
19 stop plate
19a fastening point
20 deflection pulley
21 support roller
22 lever
23 spring
24 f
25 stop
100 furniture
100a Interior
101 cavity
101a furniture wall
102 transverse guide

1. An assembly for guiding a movable furniture part, preferably a sliding door or folding-sliding door, on a fixed furniture part, the assembly comprising:
a first guide system to be fastened to the fixed furniture part,
a second guide system to be fastened to the fixed furniture part at a vertical distance from the first guide system, the two guide systems each having at least one guide and a guide body displaceably mounted on the guide,
a support to which the movable furniture part is to be fastened and which can be connected or is connected in a movement-coupled manner to the two guide bodies of the guide systems, and
a compensation device to compensate for a tilting torque of the support or of the movable furniture part arranged thereon around a tilting axis, wherein the compensation device comprises at least one cable pull device,
wherein at least one pretensioning device is provided, via which the support can be subjected to a force, preferably in the direction of a longitudinal extension of the guide of at least one of the guide systems, at least in a closed position of the movable furniture part.

2. The assembly according to claim 1, wherein the pretensioning device has at least one force accumulator, preferably a spring, particularly preferably a compression spring.

3. The assembly according to claim 1, wherein the pretensioning device has at least one plunger for contacting the support.

4. The assembly according to claim 1, wherein the pretensioning device is arranged on the fixed furniture part and/or the second guide system.

5. The assembly according to claim 1, wherein the pretensioning device is arranged on the support.

6. The assembly according to claim 1, wherein a force between 10 N and 30 N, preferably 20 N, can be exerted on the support via the pretensioning device.

7. The assembly according to claim 1, wherein the pretensioning device comprises a housing.

8. The assembly according to claim 7, wherein the force accumulator is arranged in the housing and/or the plunger is movably mounted in the housing.

9. The assembly according to claim 1, wherein the support can be subjected to a force in the area of a lower end of the support via the pretensioning device at least in a closed position.

10. The assembly according to claim 1, wherein the at least one cable pull device has at least one, preferably exactly one, cable which is fastened to the support with one end, preferably with both ends.

11. The assembly according to claim 1, wherein the at least one cable pull device has at least one cable tensioning device, using which the tension of a cable of the at least one cable pull device is adjustable, preferably wherein the at least one cable tensioning device is arranged on the support.

12. The assembly according to claim 1, wherein the at least one cable pull device has at least one deflection device, preferably having at least one deflection pulley, by means of which a cable of the at least one cable pull device can be deflected.

13. The assembly according to claim 12, wherein the at least one deflection device is arranged or can be arranged on the fixed furniture part and/or a guide system.

14. The assembly according to claim 1, wherein the compensation device is at least partially, preferably completely, pre-installed on the support in a delivery state of the assembly.

15. The assembly according to claim 2, wherein the force accumulator acts between the support and a cable terminus of the cable, preferably wherein the cable is arranged at least in some area within the force accumulator.

16. The assembly according to claim 1, wherein the pretensioning device comprises a stop, wherein the stop is arranged on the fixed furniture part, wherein at least in a closed position a stop plate arranged on the support can be brought into contact with the stop.

17. A piece of furniture having at least one fixed furniture part, at least one movable furniture part, preferably a sliding door or folding-sliding door, and the assembly according to claim 1 for guiding the movable furniture part on the fixed furniture part, preferably wherein the movable furniture part can be arranged in a shaft-shaped cavity of the furniture.

18. A method for compensating for a tilting torque of a support or of a movable furniture part arranged thereon around a tilting axis using the assembly according to claim 1, wherein in an open position and when moving the support or a movable furniture part arranged thereon between an open position and a closed position, loads resulting from a tilting torque are absorbed by the cable pull device, wherein the support is brought into contact with the pretensioning device at least in the closed position, preferably shortly before reaching the closed position or an intermediate position, which pretensioning device exerts a force on the support, preferably in the direction of a longitudinal extension of the guide of at least one of the guide systems.
